(19) United States
(12) Patent Application Publication
(10) Pub. No.: US 2006/0250203 A1
(43) Pub. Date: Nov. 9, 2006

(54) Magnetic toggle switch

(75) Inventors: George Marmaropoulos, Yorktown Heights, NY (US); Jack Kyriakos Mama, London (GB)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/557,492

(22) PCT Filed: May 24, 2004
(86) PCT No.: PCT/IB04/01730

§ 371 Date: Nov. 21, 2005

(30) Foreign Application Priority Data
May 30, 2003 (US) 60474827

(51) Int. Cl. H01H 9/00

(52) U.S. Cl. 335/205

(57) ABSTRACT

A wearable garment, usable by athletes, workers, and the elderly or infirm, incorporates an easily operated manual sliding switch, so that a user wearing the garment can operate different electronic devices by merely activating the switch through a slidable action by the user. The sliding switch comprises a housing having a sliding chamber, a conductive element disposed, and at least one magnetic element that slides up and down along the surface of the housing so as to enable an electrical connection by moving the magnetic element from one end to the other.

The present invention relates to a switch that is a part of wearable electronic devices and, in particular, to a sliding electrical switch that uses magnetic forces to move a conductive element within a sealed space in order to close a circuit integrated into conventional clothing.

Integrated electrical switches for use in clothing are typically sewn, glued, or otherwise mounted to clothing using standard “off the shelf” electric components, deemed well known in the art. Intuitive switches that utilize soft fabric materials and conductive fibers are highly desirable in wearable electronics applications as they are compatible with the manufacturing process of the garment industry.

Accordingly, the present invention relates to a garment electrical-switch system that is aimed to provide intuitive user-friendly electronic functions that are in line with the manufacturing techniques used in the garment industry for widespread acceptance.

The present invention discloses a wearable garment with a sliding switch system, which includes a housing having a sliding chamber and a conductive element disposed in the sliding chamber; and at least one magnetic element that slides up and down along the surface of the housing and is arranged to provide an electrical connection by causing the conductive element to move from one end to the other using the magnetic force.

According to one aspect of the invention, a garment of desired form and function can be constructed in a conventional manner using readily available fabrics and materials, and the sliding switch system can be positioned advantageously within a wearable garment that permits easy manual activation by a person.

According to another aspect of the invention, the sliding switch includes a housing having a sliding surface and a sliding chamber; a connector disposed in the sliding chamber; a plurality of conductive elements incorporated into a plurality of electronic devices provided along an elongated surface of the sliding chamber, and, at least one magnetic element selectively slidable from one end to the other along the sliding surface so as to cause an electrical connection between at least two conductive elements, wherein one of the plurality of electronic devices is selectable according to the position of the magnetic element along the sliding surface.

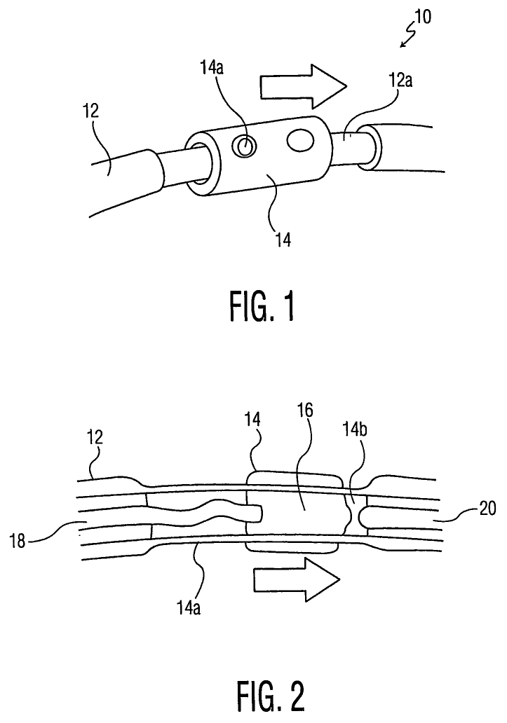

FIG. 1 illustrates an embodiment of a sliding switch system in accordance with this invention.

FIG. 2 illustrates the electrical switch system of FIG. 1 in accordance with a first embodiment of this invention.

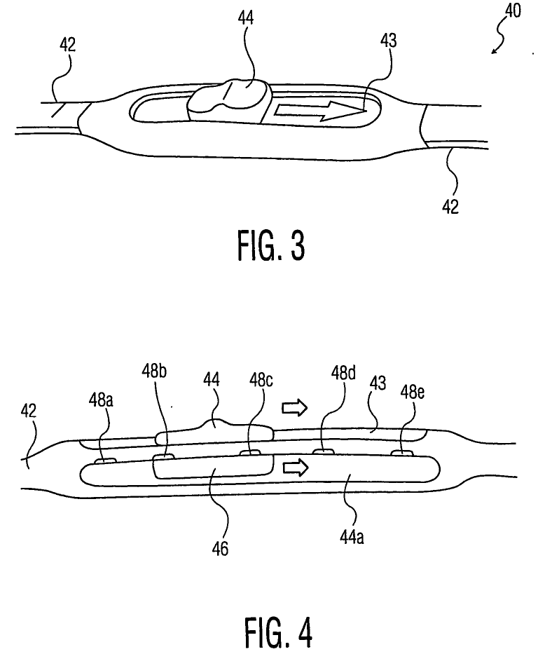

FIG. 3 is a sliding switch system in accordance with a second embodiment of this invention.

FIG. 4 illustrates a detailed construction of the inside of the sliding switch system of FIG. 3 in accordance with a second embodiment of this invention.

In the following description, for purposes of explanation rather than limitation, specific details are set forth such as the particular architecture, interfaces, techniques, etc., in order to provide a thorough understanding of the present invention. For purposes of simplicity and clarity, detailed descriptions of well-known devices, circuits, and methods are omitted so as not to obscure the description of the present invention with unnecessary detail.

Referring to FIG. 1, a sliding switch 10 in accordance with a first embodiment of the present invention includes a magnetic ring 14 that slides up and down along a flexible tube 12. It will be apparent to those skilled in the art that other shape structures from the one shown can be successfully used. The magnetic ring 14 comprises a control button or activation button 14a to enable the movement of the magnetic ring 14 along the surface 12a of the flexible tube 12. The surface 12a is formed by wood, plastic, or other non-magnetic material to enable lines of force from the magnetic ring 14 to penetrate into the flexible tube 12.

Referring to FIG. 2, the sliding switch 10 further comprises a conductive connecting element 16 moving along a sliding chamber 14b of the flexible tube 12. The movement of the conductive connecting element 16 is controlled by the magnetic lines of force and magnetic field force extended into the sliding chamber 14b by the magnetic ring 14. Moving the magnetic ring 14, as shown by the arrow, causes the inner metallic connector 18 to move accordingly and allows the conductive connecting element 16 coupled to a metallic connector 18 to touch the conductive link 20. When these three elements 14, 18, and 20 are physically and electrically connected together, the sliding switch 10 becomes a closed circuit and the power connected to the circuit is brought into operation.

In the embodiment, the sliding switch 10 maybe incorporated into a conventional garment in a location or locations most conveniently accessible to the wearer and electrically coupled to a conductive track of a fabric circuit integrated in a garment, or may activate between on and off states to engage equipment considered ancillary to the sliding switch 10, such as an external heart-monitoring device, external defibrillator, a cell phone, radio, pager, GPS device, personal communication assistant, or other signal transmitter or duplex interactive system, carried anywhere on the person of the wearer of the band. Alternatively, such ancillary equipment or other electronic devices may be integrated in the garment and used in conjunction with the sliding switch 10 for transmitting the desired signals or power in any well-known manner.

Referring to FIG. 3, a sliding switch 40 in accordance with a second embodiment of the present invention includes a magnetic element 44 that slides up and down along an elongated sliding channel 43 of a flexible tube 42. The surface of the sliding channel 43 is formed by wood, plastic, or other non-magnetic material to enable lines of force from the magnetic element 44 and to penetrate the flexible tube 42.

Referring to FIG. 4, the sliding switch 40 further provides a metallic connector 46, which is operative in response to the movement of the magnetic element 44 within a sliding chamber 44a so as to turn the switch 40 on and off. When the magnetic element 44 is moved along the sliding channel 43, as indicated by the arrow, the metallic connector 46 moves accordingly due to the magnetic lines of force and magnetic field extended into the sliding chamber 44a from the magnetic element 44. As the metallic connector 46 moves freely along the sliding chamber 43, the metal magnetic element 44 comes into contact physically and electrically with a plurality of conductive elements 48a-48d provided along the sliding surface of the sliding chamber 43. It is noted that a row of the conductive elements 48a-48d is incorporated into a number of electronic circuits, so that different electronic devices can be selectively actuated according to the position of the metallic connector 46 that comes into contact with the conductive elements. For example, the conductive elements 48a and 48b may represent a first electronic circuit and the conductive elements 48b and 48c may represent a second electronic circuit, etc. Thus, moving the magnetic element 44 to come into contact with at least two conductive elements electrically and physically can trigger to actuate, operate, or switch different circuits.

Accordingly, a wearer can engage the sliding switch 40 readily by merely moving the magnetic element 44 along the sliding chamber 43 to activate a number of different electronic circuits. As stated earlier, the sliding switch 40 can be electrically coupled to a conductive track of a fabric circuit integrated in a garment, or coupled to engage equipment considered ancillary, such as an external heart-monitoring device, external defibrillator, a cell phone, radio, pager, GPS device, personal communication assistant, or other signal transmitter or duplex interactive system, carried anywhere on the person of the wearer of the band. In an alternate embodiment, ancillary equipment may be integrated in the garment and used in conjunction with the sliding switch 40 for transmitting the desired signals or power in any well-known manner. Although a limited number of conductive elements are shown in FIG. 4 for illustrative purposes, it is to be understood that the present invention can support a larger number of circuits. Thus, the number of conductive elements in the drawing should not impose limitations on the scope of the invention.

Having thus described preferred embodiments of a switching system, it should be apparent to those skilled in the art that certain advantages of the system have been achieved. For example, as the outside magnetic ring 12 or the magnetic element 44 is not directly connected to the metallic connector to close a circuit, the present invention provides an excellent waterproof solution. Moreover, the inventive switch system can be readily integrated in a conventional garment such as a sleeveless top shirt that may be long-sleeved, short-sleeved, vest, or jacket, etc.

While the preferred embodiments of the present invention have been illustrated and described, it will be understood by those skilled in the art that various changes and modifications can be made, and equivalents maybe substituted for elements thereof without departing from the true scope of the present invention. Therefore, it is intended that the present invention not be limited to the particular embodiment disclosed as the best mode contemplated for carrying out the present invention, but that the present invention include all embodiments falling within the scope of the appended claims.

What is claimed is:

1. A sliding switch comprising:
a housing (12) having a sliding chamber and a conductive element (16) disposed in said sliding chamber, and
at least one magnetic element (14) that slides up and down along the surface of said housing (12) and arranged to provide an electrical connection by causing said conductive element (16) to move from one end to the other.

2. The sliding switch of claim 1, further comprising a control device (14a) on said magnetic element (14) to activate the movement of said magnetic element (14) along the surface of said housing (12).

3. The sliding switch of claim 1, wherein said magnetic element (14) further comprises a conductive cable (18) extending therefrom.

4. The sliding switch of claim 1, wherein the surface of said housing (12) is made of a hollow tube of nonmagnetic material.

5. The sliding switch of claim 1, wherein said sliding switch is coupled to a wearable garment.

6. The sliding switch of claim 5, wherein the movement of said magnetic element (16) serves as an electrical connection to an electronic device.

7. The sliding switch of claim 5, wherein the movement of said magnetic element (16) serves as an electrical connection to a power source.

8. The sliding switch of claim 5, wherein said sliding switch is mounted to the outer surface of said garment for engaging and supporting units ancillary to transmitting electronic signals.

9. A sliding switch comprising:
a housing (42) having a sliding surface and a sliding chamber,
a connector (46) disposed in said sliding chamber (42a);
a plurality of conductive elements (48a-48e) provided along an elongated surface (43) of said sliding chamber (42a); and
at least one magnetic element (44) selectively slidable from one end to the other along said sliding surface (43) so as to cause an electrical connection between at least two conductive elements.

10. The sliding switch of claim 9, wherein the plurality of said conductive elements (48a-48e) is incorporated into a number of electronic devices so that a plurality of different electrical output signals can be provided.

11. The sliding switch of claim 10, wherein one of the plurality of said electronic devices is selectable by the position of said magnetic element (44) along said sliding surface (43).

12. The sliding switch of claim 9, wherein the plurality of conductive elements (48a-48e) is incorporated into a number of electronic circuits so that different devices can be actuated according to the position of said magnetic element (44) along said sliding surface (43).

13. The sliding switch of claim 9, wherein said sliding switch is coupled to a wearable garment.

14. The sliding switch of claim 13, wherein said sliding switch is mounted to the outer surface of said garment for engaging and supporting units ancillary to transmitting electronic signals.

15. A method for permitting a person to activate an electronic device conveniently, said method comprising the steps of:
mounting a sliding switch having a housing (12), which includes a sliding chamber, a conductive element (16) disposed in said sliding chamber, and a magnetic element (14) slidably mounted around said housing (12) to said wearable garment;
dressing said person in said wearable garment; and,
selectively coupling said switch by moving said magnetic element from one end to the other of said housing (12) to serve as a coupling to an electronic device or a power source.

16. A method for permitting a person to activate an electronic device conveniently, said method comprising the steps of:
mounting a sliding switch having a housing (42), which includes a sliding chamber (44a), a connector (46) disposed in said sliding chamber, and a magnetic element (44) slidably mounted to a sliding surface (43) of said housing (42) to said wearable garment, said switch further comprises a plurality of conductive elements (48a-48e) provided along an elongated surface (43) of said sliding chamber (44a) incorporated into a number of electronic devices;
dressing said person in said wearable garment; and
activating one of said electronic devices according to the position of said magnetic element (44) along said sliding surface.
